(19) United States
(12) Patent Application Publication
(10) Pub. No.: US 2026/0149271 A1
(43) Pub. Date: May 28, 2026

(54) POWER ELECTRIC CIRCUIT

(71) Applicant: STMicroelectronics International N.V., Geneva (CH)

(72) Inventors: Jean Pierre PROOT, Tours (FR); Eric COLLEONI, Tours (FR)

(21) Appl. No.: 19/389,423

(22) Filed: Nov. 14, 2025

(30) Foreign Application Priority Data
Nov. 28, 2024 (FR) 2413163

(51) Int. Cl. H02J 1/08; B60L 58/10

(52) U.S. Cl. CPC H02J 1/084; B60L 58/10; H02J 2105/37

(57) ABSTRACT

The present disclosure relates to an electric power circuit, comprising at least: several power supply sources; an electric interconnection bus coupled to the power supply sources; and switching devices each comprising at least a thyristor and a field-effect transistor parallelly coupled to each other, and configured to serially or parallelly couple the power supply sources.

### CROSS REFERENCE TO RELATED APPLICATION

This application claims the priority benefit of French Patent Application Number 2413163, filed on Nov. 28, 2024, entitled “Circuit électrique de puissance”, which is hereby incorporated by reference to the maximum extent allowable by law.

### TECHNICAL FIELD

The present disclosure relates generally to the field of power electricity, and more particularly that of power electrical circuits in which power supply sources are coupled to an electric interconnection bus.

### BACKGROUND

In an electric vehicle such as an electric car, the battery(ies) of the vehicle is (are) coupled to a high-voltage interconnection bus of the vehicle by electromechanical contactors or relays being controlled by inductor circuits comprising electromagnetic windings. These electromechanical contactors may be replaced with semiconductor power switches, such as MOSFETs (Metal-Oxide-Semiconductor Field Effect Transistors) based on wide-bandgap semiconductors being more efficient and reliable.

However, an electromagnetic contactor has a low ON resistance, typically less than or equal to 1 milliohm (mΩ). For example, considering a current equal to 700 amps (A) passing through such an electromagnetic contactor the ON resistance of which is equal to 1 mΩ, the power dissipated by the contactor is equal to 0.7 volts (V)*700 A=490 watts (W). To get performance similar with a power MOSFET made of SiC (silicon carbide) the ON resistance of which is higher, for example equal to 7 mΩ, several (seven in the described example) transistors have to be parallelly coupled which in addition need an appropriate cooling. The cost of such a solution is too high as compared to that of a single electromechanical contactor. In addition, there is a thermal runaway hazard due to the positive temperature factor of transistors (the greater the temperature of transistors, the greater their resistance).

Another drawback of MOSFETs lies in that their losses increase along with the temperature. Thus, in the previously described example, if seven transistors may be sufficient for a use at 25° C., using at least eight transistors could be needed for a use at a higher temperature, for example equal to 150° C.

### BRIEF SUMMARY

There is a need to provide an electric power circuit having not at least a part of the drawbacks of the existing solutions.

One embodiment overcomes all or part of the drawbacks of the known solutions and provides an electric power circuit comprising at least: a plurality of power supply sources; an electric interconnection bus coupled to the power supply sources; and switching devices each comprising at least a thyristor and a field-effect transistor parallelly coupled to each other, and configured to serially or parallelly couple the power supply sources.

According to a particular embodiment, the power supply sources are batteries.

According to a particular embodiment, the field-effect transistors of the switching devices are MOSFETs.

According to a particular embodiment, the field-effect transistors of the switching devices include SiC.

According to a particular embodiment, the field-effect transistors of the switching devices are of the N-type.

According to a particular embodiment, a first one of the power supply sources include a positive electrode coupled to a first conductive element of the electric interconnection bus, and a second one of the power supply sources includes a negative electrode coupled to a second conductive element of the electric interconnection bus.

According to a particular embodiment, a negative electrode of the first power supply source is coupled to a positive electrode of the second power supply source by first and second switching devices serially coupled to each other, and so that they together form a two-way conduction path between the negative electrode of the first power supply source and the positive electrode of the second power supply source.

According to a particular embodiment: the field-effect transistors of the first and second switching devices are of the N-type; the sources of the field-effect transistors of the first and second switching devices are coupled to each other; the drain of the field-effect transistors of the first switching device, the anode of the thyristor of the first switching device, and the cathode of the thyristor of the second switching device are coupled to the negative electrode of the first power supply source; and the drain of the field-effect transistors of the second switching device, the anode of the thyristor of the second switching device, and the cathode of the thyristor of the first switching device are coupled to the positive electrode of the second power supply source.

According to a particular embodiment, the negative electrode of the first power supply source is coupled to the negative electrode of the second power supply source by a third switching device, and the positive electrode of the first power supply source is coupled to the positive electrode of the second power supply source by a fourth switching device.

According to a particular embodiment: the field-effect transistors of the third and fourth switching devices are of the N-type; the source of the transistor of the third switching device and the cathode of the thyristor of the third switching device are coupled to the negative electrode of the second power supply source; the drain of the transistor of the third switching device and the anode of the thyristor of the third switching device are coupled to the negative electrode of the first power supply source; the source of the transistor of the fourth switching device and the cathode of the thyristor of the fourth switching device are coupled to the positive electrode of the second power supply source; and the drain of the transistor of the fourth switching device and the anode of the thyristor of the fourth switching device are coupled to the positive electrode of the first power supply source.

According to a particular embodiment, the electric power circuit further comprises at least one electromechanical contactor via which the power supply sources are coupled to the electric interconnection bus.

According to a particular embodiment, each of the first and second conductive element of the bus is coupled to one of electrodes of one of the power supply sources by an electromechanical contactor.

According to a particular embodiment, each of the power supply sources is configured to have across its terminals an electric voltage comprises between 12 V and 1000 V.

According to a particular embodiment, the electric power circuit further includes a control circuit configured to control the switching devices so that the power supply sources are serially or parallelly coupled to the electric interconnection bus depending on the operating mode of the electric power circuit.

It is also disclosed an electric vehicle comprising at least a power circuit according to a particular embodiment.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates an example electric power circuit according to one specific embodiment;

FIG. 2 illustrates conduction currents obtained in a switching device of an electric power circuit according to one specific embodiment, as well as in a single field-effect transistor, in a single thyristor, and in several parallelly coupled field-effect transistors;

FIG. 3 illustrates conduction currents obtained in a field-effect transistor and in a thyristor of a switching device of an electric power circuit according to one specific embodiment; and

FIG. 4 illustrates an electric vehicle comprising an electric power circuit according to one specific embodiment.

### DETAILED DESCRIPTION

Like features have been designated by like references in the various figures. In particular, the structural and/or functional features that are common among the various embodiments may have the same references and may dispose identical structural, dimensional and material properties. In the figures, in order to make them easier to read, the different elements are not drawn at a same scale from one to the other.

For the sake of clarity, only the operations and elements that are useful for an understanding of the embodiments described herein have been illustrated and described in detail. In particular, different elements (power supply sources, electric interconnection bus, switching devices, electromechanical contactor, electric vehicle, etc.) are not described in detail. Those skilled in the art will be able to implement in detail these elements based on the functional description provided herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements. Further, the terms “coupled”, “linked”, and “connected” are used here to designate electric coupling, linking, or connections.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures. However, these terms do not presage the actual position and orientation of the circuit in use.

Likewise, unless specified otherwise, the indicated ranges of values include the ends of these ranges.

Unless specified otherwise, the expressions “around”, “approximately”, “substantially” and “in the order of” signify within 10%, and preferably within 5%.

In all described embodiments, for each field-effect transistor, the first and second conduction electrodes correspond to two electrodes of the same transistor different from each other, one of which corresponding to the source electrode, and the other one corresponding to the drain electrode.

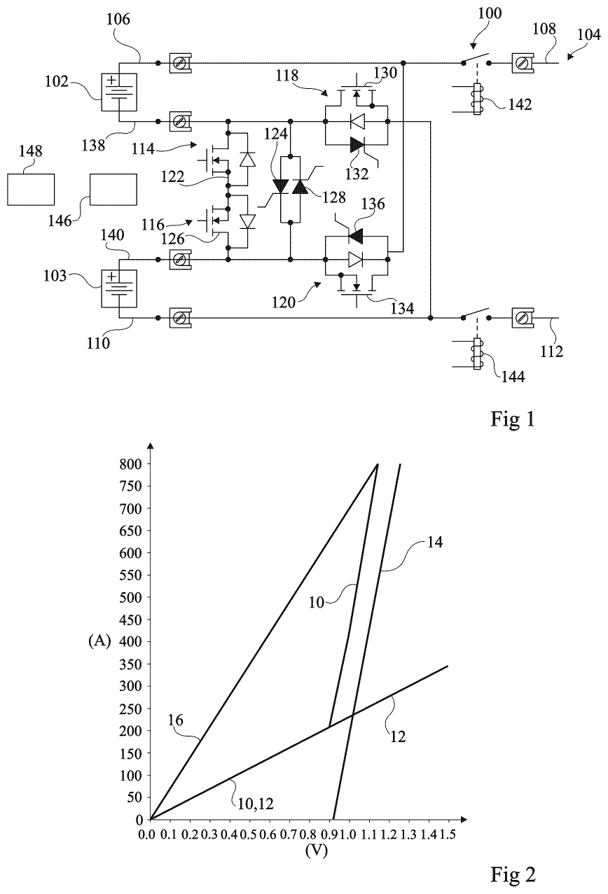

FIG. 1 described hereinafter illustrates an example electric power circuit 100 according to one specific embodiment. In this example, the circuit 100 corresponds to an electric power circuit of an electric vehicle, such as an electric car.

Circuit 100 includes several power supply sources which in the described example, are intended to supply power to the electric vehicle. In the example shown in FIG. 1, circuit 100 includes two power supply sources 102, 103 corresponding to two batteries. In the described example, these power supply sources 102, 103 are intended to supply power to an electric vehicle, and output each across its terminals an electric voltage equal to around 400 V, or more generally of between 12 V and 1000 V, or between 12 V and 560 V.

The circuit 100 also includes an electric interconnection bus 104 to which the power supply sources 102, 103 are coupled. According to one specific example embodiment, a first one 102 of the power supply sources includes a positive electrode 106 coupled to a first conductive element 108 of the bus 104, and a second one 103 of the power supply sources includes a negative electrode 110 coupled to a second conductive element 112 of the bus 104.

In the described example embodiment, the circuit 100 also includes, not illustrated in FIG. 1, other electric, electromechanical, or electronic elements or components coupled to the bus 104, among which in particular one or several electric motors of the vehicle, a part of which being the circuit 100.

Circuit 100 further comprises switching devices each comprising at least one thyristor, or SCR (Silicon Controlled Rectifier), and a field-effect transistor parallelly coupled to each other. These switching devices are configured to serially or parallelly couple the power supply sources 102, 103 to each other. In the described example embodiment, the circuit 100 includes first and second switching devices 114, 116 configured to serially couple the power supply sources 102, 103 (which are then serially coupled between the first and second conductive elements 108, 112 of the bus 104 of the described example), and third and fourth switching devices 118, 120 configured to parallelly couple the power supply sources 102, 103 (which are then parallelly coupled, and having one of their electrodes coupled to the first conductive element 108 of the bus 104, and the other of their electrodes coupled to the second conductive element 112 of the bus 104).

In the described example embodiment, the field-effect transistor of each of the switching devices 114-120 correspond to a power MOSFET. Further, in the described example embodiment, these field-effect transistors are implemented based on at least one wide-bandgap semiconductor suitable for conducting high electric currents, such as SiC. Further, in the described example embodiment, these field-effect transistors are of the N-type. In FIG. 1, each of the MOSFETs of the switching devices 114-120 is illustrated with its body diode.

In the example shown in FIG. 1, the first switching device 114 includes a first field-effect transistor 122 and a first thyristor 124, the second switching device 116 includes a second field-effect transistor 126 and a second thyristor 128, the third switching device 118 includes a third field-effect transistor 130 and a third thyristor 132, and the fourth switching device 120 includes a fourth field-effect transistor 134 and a fourth thyristor 136.

In the described example embodiment, a negative electrode 138 of the first power supply source 102 is coupled to a positive electrode 140 of the second power supply source 103 by the first and second switching devices 114, 116 serially coupled to each other, and so that they form together a two-way conduction path between these electrodes 138, 140 of the sources 102, 103. The first and second switching devices 114, 116 allow as they are ON, a serial coupling of the power supply sources 102, 103 to each other to be performed between the first and second conductive elements 108, 112 of the bus 104.

In the example shown in FIG. 1: the sources of first and second transistors 122, 126 of the first and second switching devices 114, 116 are coupled to each other; the drain of the first transistor 122 of the first switching device 114, the anode of the first thyristor 124 of the first switching device 114, and the cathode of the second thyristor 128 of the second switching device 116 are coupled to the negative electrode 138 of the first power supply source 102; and the drain of the second transistor 126 of the second switching device 116, the anode of the second thyristor 128 of the second switching device 116, and the cathode of the first thyristor 124 of the first switching device 114 are coupled to the positive electrode 140 of the second power supply source 103.

In the described example embodiment, the negative electrode 138 of the first power supply source 102 is coupled to the negative electrode 110 of the second power supply source 103, and also to the second conductive element 112 of the bus 104, by the third switching device 118. In addition, the positive electrode 106 of the first power supply source 102 is coupled to the positive electrode 140 of the second power supply source 103, and also to the first conductive element 108 of the bus 104, by the fourth switching device 120. The third and fourth switching devices 118, 120 allow as they are at the ON state, parallelly coupling the first and second power supply sources 102, 103 to each other to be performed between the first and second conductive elements 108, 112 of the bus 104.

In the example shown in FIG. 1: the source of the third transistor 130 and the cathode of the third thyristor 132 of the third switching device 118 are coupled to the negative electrode 110 of the second power supply source 103; the drain of the third transistor 130 and the anode of the third thyristor 132 of the third switching device 118 are coupled to the negative electrode 138 of the first power supply source 102; the source of the fourth transistor 134 and the cathode of the fourth thyristor 136 of the fourth switching device 120 are coupled to the positive electrode 140 of the second power supply source 103; and the drain of the fourth transistor 134 and the anode of the fourth thyristor 136 of the fourth switching device 120 are coupled to the positive electrode 106 of the first power supply source 102.

In the described example embodiment, the circuit 100 further comprises at least one electromechanical contactor via which the power supply sources 102, 103 are coupled to the bus 104. More particularly, in the described example, each of the first and second conductive elements 108, 112 of the bus 104 is coupled to one of the electrodes of one of the power supply sources 102, 103 by an electromagnetic contactor 142, 144. In the example shown in FIG. 1, a first electromechanical contactor 142 provides the outage or not of the electric link between the first conductive element 108 of the bus 104, and the positive electrode 106 of the first power supply source 102, and the second electromechanical contactor 144 provides the outage or not of the electric link between the second conductive element 112 of the bus 104, and the negative electrode 110 of the second power supply source 103. More generally, the circuit 100 can include at least one electromechanical contactor, or relay, on a link of the circuit 100 where a galvanic insulation is likely to be formed.

In the described example embodiment, the circuit 100 further includes a control circuit 146 configured to control the switching devices 114-120, i.e., transistors 122, 126, 130, 134 and the thyristors 124, 128, 132, 136, so that power supply sources 102, 103 are serially or parallelly coupled to the bus 104 depending on the operating mode of the circuit 100. More particularly, the gates of transistors 122, 126, 130, 134 and the gates of thyristors 124, 128, 132, 136 are coupled to outputs of the control circuit 146 on which control signals are provided (in FIG. 1, these links are not illustrated). One or more outputs of the control circuit 146 can also be coupled to control inputs of electromechanical contactors 142, 144 in order to control the outage of the link between the bus 104 and the power supply sources 102, 103 when necessary.

In the described example embodiment, the circuit 100 further includes a cooling device 148, symbolically illustrated in FIG. 1, configured to cool the switching devices 114-120 of the circuit 100. For example, device 148 can be configure so that the junction temperature of each thyristor 124, 128, 132, 136 does not exceed around 150° C. For example, the device 148 can be configured to force a cooling liquid to flow in the vicinity of the switching devices 114-120.

By way of example, the hereinafter table indicates, for different values of the thermal resistance junction-package of a thyristor of one of the switching devices 114-120, denoted RTH (j-c) thy, different characteristic values obtained in the circuit 100: the total conduction current obtained in the switching devices 114-120, the conduction current in the thyristor, the conduction current in the transistor of the switching device 114-120, the voltage across the switching devices 114-120 (denoted Vds as this voltage is equal to the voltage Vds across the source and drain of the transistor, and to the voltage across the anode and cathode of the thyristor of the switching device), and the junction temperature of the transistor of the switching device 114-120. These different values are obtained for a cooling temperature of 60° C., for a SiC-based MOSFET transistor the serial resistance of which is equal to 10.5 mΩ, and for a thyristor the area of which is equal to 60 square millimeters (mm²). For these different values of thermal resistance of the thyristor, the thermal resistance junction-package of the transistor of the switching device 114-120 is equal to 0.176° C./W, and the junction temperature of the thyristor is equal to 150° C.

TABLE 1

| | Total | Thy | Trans | | |
|---|---|---|---|---|---|
| RTH(j-c) thy | current | current | current | Vds | Trans Tj |
| (° C./W) | (A) | (A) | (A) | (V) | (° C.) |
| 0.29 | 350 | 247 | 103 | 1.252 | 82.7 |
| 0.27 | 366 | 261 | 105 | 1.275 | 83.5 |
| 0.25 | 383 | 277 | 106 | 1.3 | 84.3 |
| 0.23 | 403 | 295 | 108 | 1.328 | 85.3 |
| 0.21 | 425 | 315 | 110 | 1.358 | 86.4 |
| 0.19 | 452 | 339 | 113 | 1.395 | 87.7 |
| 0.17 | 484 | 368 | 116 | 1.437 | 89.2 |
| 0.15 | 522 | 403 | 119 | 1.485 | 91.1 |
| 0.13 | 570 | 447 | 127 | 1.544 | 93.3 |
| 0.11 | 632 | 506 | 127 | 1.618 | 96.3 |
| 0.09 | 716 | 583 | 133 | 1.715 | 100.1 |

The value of the total current which crosses the switching device 114-120 depends on the cooling device 148 and of the thermal resistance intended to be obtained for the thyristors. The above table shows the calculated values of thermal resistance required for currents between 350 A and 716 A, with a cooling equal to 60° C.

In the described example, the power supply sources 102, 103 are serially coupled to each other and to the bus 104 when the first and second transistors 122, 126 and the first and second thyristors 124, 128 are ON. In addition, the power supply sources 102, 103 are parallelly coupled to each other and to the bus 104 when the third and fourth transistors 130, 134 and the third and fourth thyristors 132, 136 are ON. In the described example, the first and second switching devices 114, 116 together form a two-way switching circuit, i.e., capable of conducting a current in two opposite directions, and the third and fourth switching devices 118, 120 each form a one-way switching circuit, i.e., capable of conducting a current in a single direction.

The bidirectional feature of the switching circuit formed by the switching devices 114, 116 enables, for example, the conduction of a positive current when one or more motors powered by the power supply sources 102, 103, which correspond for example to battery packs, drive the vehicle, and the conduction of a negative charging current (with respect to the biasing of the power sources 102, 103), for example obtained when the vehicle brakes or when recharging at a charging station supplying a voltage equal to the sum of the voltages at the terminals of the power sources 102, 103, is transmitted to the power sources 102, 103. In addition, the power sources 102, 103 can be coupled in parallel with each other when recharging the power sources 102, 103 at a recharging station supplying a voltage, for example, equal to the terminal voltage of one of the power sources 102, 103.

Alternatively, the third and fourth switching devices 118, 120 can be used to couple only to each other the power supply sources 102, 103 to the bus 104. For example, it is possible that only the first power supply source 102 is coupled to the bus 104 by configuring OFF the first, second, and fourth transistors 122, 126, 134 and thyristors 124, 128, 136 of the switching devices 114, 116, 120, and by configuring ON the third transistor 130 and the third thyristor 132 of the third switching device 118. Likewise, it is possible that only the second power supply source 103 is coupled to the bus 104 by configuring OFF the first, second, and third transistors 122, 126, 130 and thyristors 124, 128, 132 of the switching devices 114, 116, 118, and by configuring ON the fourth transistor 134 and the fourth thyristor 136 of the fourth switching device 120. Such a configuration may correspond, for example, when the power supply sources 102, 103 correspond to battery packs, to charging one of the power supply sources 102, 103, then charging the other of the power supply sources 102, 103, bearing in mind, however, that it is desirable to maintain the same level of charging of the battery packs.

Thus, within circuit 100, is described the use of switching devices each comprising a power field-effect transistor, for example a SiC-based MOSFET and a thyristor parallelly coupled to each other. In such a switching device, the transistor alone allows the current to be conducted up to a first value, for example equal to around 200 A. Beyond this first value, the current is conducted in a way shared among the transistor and the thyristor. For example, for a total current equal to 700 A to be conducted by the switching device, a first part of this current, e.g., equal to 250 A, can be conducted by the power MOSFET and a second part of this current, e.g., equal to 450 A, can be conducted by the thyristor.

Curve 10 shown in FIG. 2 illustrates the value of the current conducted by such a switching device as a function of the value of the voltage across its terminals. For comparison, curve 12 illustrates the value of the current conducted by a SiC-based power MOSFET similar to that of the switching device, and curve 14 illustrates the value of the current conducted by a thyristor similar to that of the switching device. In this example, when the voltage across the switching device is less than the voltage from which the thyristor turns ON, e.g., equal to around 0.9 V, the conduction of the current is performed by the power MOSFET alone. Beyond this voltage value, the thyristor of the switching device turns ON and its conduction is added to that of the power MOSFET. The thyristor has a conduction capability higher than that of the transistor. Curve 16 shown in FIG. 2 illustrates the value of the current conducted by eight power MOSFETs similar to that of the switching device, and parallelly coupled to each other. With a voltage slightly higher than 1 V across its terminals, the switching device allows a current equal to 800 A, that is as much as the eight MOSFETs parallelly coupled. The different curves illustrated in FIG. 2 are obtained at an operation temperature equal to 25° C.

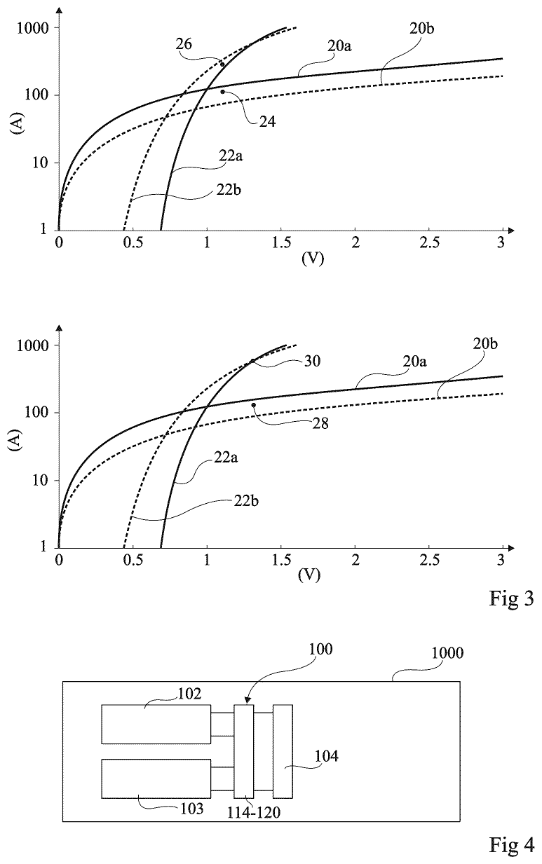

In FIG. 3, curve 20a illustrates the value of the conduction current obtained, at a temperature equal to 25° C., in a SiC-based MOSFET transistor of one of the switching devices 114-120, and having a ON resistance equal to 8.5 mΩ, as a function of the voltage across its terminals. Curve 20b shows the value of this current during hot-running operation of this transistor. Curve 22a illustrates the value of the conduction current obtained, at a temperature equal to 25° C., in a thyristor of one of the switching devices 114-120, and having an active area equal to 120 mm². Curve 22b shows the value of this current during hot-running of this thyristor.

The operating point designated by reference 24 corresponds to the conduction characteristic of the transistor obtained when the voltage across the source and drain of transistor is equal to 1.111 V. At this operating point, the conduction current of the transistor is equal to 113.1 A, the power dissipated by the transistor is equal to 125.6 W, and the junction temperature of the transistor is equal to 82.1° C. The operating point designated by reference 26 corresponds to the conduction characteristic of the thyristor obtained when the voltage across the anode and cathode of thyristor is equal to 1.111 V. At this operating point, the conduction current of the thyristor is equal to 286.9 A (the total conduction current of the switching device thus being equal to 400 A), the power dissipated by the thyristor is equal to 318.7 W (the total power dissipated by the switching device is thus equal to 444.4 W), and the junction temperature of the thyristor is equal to 95.1° C.

The operating point designated by reference 28 corresponds to the conduction characteristic of the transistor obtained when the voltage across the source and drain of transistor is equal to 1.317 V. At this operating point, the conduction current of the transistor is equal to 130.6 A, the power dissipated by the transistor is equal to 171.9 W, and the junction temperature of the transistor is equal to 90.3° C. The operating point designated by reference 30 corresponds to the conduction characteristic of the thyristor obtained when the voltage across the anode and cathode of thyristor is equal to 1.317 V. At this operating point, the conduction current of the thyristor is equal to 569.4 A (the total conduction current of the switching device thus being equal to 400 A), the power dissipated by the thyristor is equal to 750 W (the total power dissipated by the switching device is thus equal to 921.9 W), and the junction temperature of the thyristor is equal to 142.5° C.

In each switching device 114-120, the transistor can conduct alone the conduction current until the thyristor turns ON. The value of the current conducted by the transistor can especially depend on the value of the ON resistance (Ron).

Each switching device 114-120 allows conduction and thermal dissipation performances similar to that of several power MOSFETs parallelly coupled to be obtained, at a lower cost and a small footprint. In addition, the cost of such switching devices is competitive as compared to that of electromechanical contactors.

Such switching devices 114-120 have the advantage of low losses. Indeed, in each of the switching devices 114-120, the ON resistance of the field-effect transistor is for example less than 10 mΩ, and that of the thyristor is for example less than 2 mΩ.

In such a switching device 114-120, the thyristor allows a possible overload current flowing through the circuit to be better tolerated as compared to several MOSFETs parallelly coupled to each other.

Further, with such switching devices 114-120, the distribution of the conduction current between the transistor and the thyristor is not a problem, unlike a switching device comprising several transistors parallelly coupled to each other in which the manufacturing differences between the transistors can cause a non-homogenous current distribution among transistors.

Further, in such switching devices 114-120 a temperature compensation naturally occurs given that the negative temperature factor of the thyristor compensating the thermal behavior of the transistor, the temperature factor of which is positive, and thus avoids a thermal runaway occurrence within the switching device.

Each switching device 114-120 allows a good power dissipation, and does not request outage at high current levels.

For example, the circuit 100 can be part of an electric vehicle 1000 as schematically illustrated in FIG. 4. In this example, the power supply sources 102, 103 correspond to the vehicle batteries 1000, and the electric interconnection bus 104 allows these batteries to be conned to the engine(s) of the vehicle 1000.

The circuit 100 can correspond to a DC or AC power circuit, depending on the type of voltages output by the power supply sources 102, 103. As an alternative to the example circuit 100 previously described, the batteries can be replaced with other types of power supply sources, providing for example a DC current and voltage. When the circuit 100 corresponds to an AC power circuit, the circuit 100 can not include the electromechanical relays 142, 144 since it is in this configuration easy to switch OFF the thyristors of the switching devices 114-120.

In the examples previously described, the field-effect transistors of the switching devices 114-120 are of the N-type. Alternatively, these field-effect transistors can be of the P-type. In this case, the connections of the conduction electrodes of the field-effect transistors are inverted as compared to the described examples (connection of the source instead of the drain and vice-versa). The values of the control signals applied on the gates of such transistors are also adapted to the type of the transistor conductivity.

The power electric circuit is for example intended to the automotive industry. Electrifying motor vehicles causes a higher and higher level of electronic content in vehicles. The device for example comprises thyristors, rectifiers, high voltage transient voltage suppression diodes, modules, etc. intended to be integrated within said vehicles. Driving automation also causes an electronic content increasingly high within vehicles. The device comprises for example high voltage transient voltage suppression diodes, an electromagnetic discharge protection, and common mode filters to protect against electric hazards within the emerging complex electronics.

The power electric circuit is for example intended to automotive industry, applied to the batteries reconfiguration according to features of the charging terminal to which the circuit is coupled.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

1. A power electrical circuit comprising:
a plurality of power supply sources;
an electrical interconnection bus coupled to the plurality of power supply sources; and
switching devices each comprising at least one thyristor and one field-effect transistor coupled in parallel with each other, and configured to couple the plurality of power supply sources in series or parallel;
wherein a first power supply source comprises a positive electrode coupled to a first conductive element of the electrical interconnection bus, and a second power supply source comprises a negative electrode coupled to a second conductive element of the electrical interconnection bus;
wherein, in a first configuration, a negative electrode of the first power supply source is coupled to a positive electrode of the second power supply source by first and second switching devices coupled in series and forming together a bidirectional conduction path between the negative electrode of the first power supply source and the positive electrode of the second power supply source;
wherein (i) the field-effect transistors of the first and second switching devices are n-type, (ii) sources of the field-effect transistors of the first and second switching devices are coupled to each other, (iii) a drain of the field-effect transistor of the first switching device, an anode of the thyristor of the first switching device, and a cathode of the thyristor of the second switching device are coupled to the negative electrode of the first power supply source, (iv) the drain of the field-effect transistor of the second switching device, the anode of the thyristor of the second switching device, and the cathode of the thyristor of the first switching device are coupled to the positive electrode of the second power supply source, or (v) the negative electrode of the first power supply source is coupled to the negative electrode of the second power supply source by a third switching device, and the positive electrode of the first power supply source is coupled to the positive electrode of the second power supply source by a fourth switching device;
wherein (i) the field-effect transistors of the third and fourth switching devices are n-type, (ii) a source of the transistor of the third switching device and the cathode of the thyristor of the third switching device are coupled to the negative electrode of the second power supply source, (iii) the drain of the transistor of the third switching device and the anode of the thyristor of the third switching device are coupled to the negative electrode of the first power supply source; (iv) a source of the transistor of the fourth switching device and the cathode of the thyristor of the fourth switching device are coupled to the positive electrode of the second power supply source, and (v) the drain of the transistor of the fourth switching device and the anode of the thyristor of the fourth switching device are coupled to the positive electrode of the first power supply source.

2. The power electrical circuit according to claim 1, wherein the plurality of power supply sources are batteries.

3. The power electrical circuit according to claim 1, wherein the field-effect transistors of the switching devices are MOSFETs.

4. The power electrical circuit according to claim 1, wherein the field-effect transistors of the switching devices comprise SiC.

5. The power electrical circuit according to claim 1, wherein the field-effect transistors of the switching devices are n-type.

6. The power electrical circuit according to claim 1, wherein a first power supply source comprises a positive electrode coupled to a first conductive element of the electrical interconnection bus; and
wherein a second power supply source comprises a negative electrode coupled to a second conductive element of the electrical interconnection bus.

7. The power electrical circuit according to claim 6, wherein a negative electrode of the first power supply source is coupled to a positive electrode of the second power supply source by first and second switching devices coupled in series and forming together a bidirectional conduction path between the negative electrode of the first power supply source and the positive electrode of the second power supply source.

8. The power electrical circuit according to claim 7, wherein:
the field-effect transistors of the first and second switching devices are n-type;
the sources of the field-effect transistors of the first and second switching devices are coupled to each other;
the drain of the field-effect transistor of the first switching device, the anode of the thyristor of the first switching device, and the cathode of the thyristor of the second switching device are coupled to the negative electrode of the first power supply source; and
the drain of the field-effect transistor of the second switching device, the anode of the thyristor of the second switching device, and the cathode of the thyristor of the first switching device are coupled to the positive electrode of the second power supply source.

9. The power electrical circuit according to claim 6, wherein the negative electrode of the first power supply source is coupled to the negative electrode of the second power supply source by a third switching device; and
wherein the positive electrode of the first power supply source is coupled to the positive electrode of the second power supply source by a fourth switching device.

10. The power electrical circuit according to claim 9, wherein:
the field-effect transistors of the third and fourth switching devices are n-type;
the source of the transistor of the third switching device and the cathode of the thyristor of the third switching device are coupled to the negative electrode of the second power supply source;
the drain of the transistor of the third switching device and the anode of the thyristor of the third switching device are coupled to the negative electrode of the first power supply source;
the source of the transistor of the fourth switching device and the cathode of the thyristor of the fourth switching device are coupled to the positive electrode of the second power supply source; and
the drain of the transistor of the fourth switching device and the anode of the thyristor of the fourth switching device are coupled to the positive electrode of the first power supply source.

11. The power electrical circuit according to claim 6, wherein each of the first and second conductive elements of the bus is coupled to one of the electrodes of one of the plurality of power supply sources via an electromechanical contactor.

12. The power electrical circuit according to claim 1, further comprising at least one electromechanical contactor through which the plurality of power supply sources are coupled to the electrical interconnection bus.

13. The power electrical circuit according to claim 1, wherein each of the plurality of power supply sources is configured to present at its terminals an electrical voltage between 12 V and 1000 V.

14. The power electrical circuit according to claim 1, further comprising a control circuit configured to control the switching devices so that the plurality of power supply sources are coupled in series or parallel to the electrical interconnection bus according to an operating mode of the power electrical circuit.

15. An electric vehicle comprising:
at least one power circuit comprising:
a plurality of power supply sources;
an electrical interconnection bus coupled to the plurality of power supply sources; and
switching devices each comprising at least one thyristor and one field-effect transistor coupled in parallel with each other, and configured to couple the plurality of power supply sources in series or parallel;
wherein a first power supply source comprises a positive electrode coupled to a first conductive element of the electrical interconnection bus, and a second power supply source comprises a negative electrode coupled to a second conductive element of the electrical interconnection bus;
wherein, in a first configuration, a negative electrode of the first power supply source is coupled to a positive electrode of the second power supply source by first and second switching devices coupled in series and forming together a bidirectional conduction path between the negative electrode of the first power supply source and the positive electrode of the second power supply source;
wherein (i) the field-effect transistors of the first and second switching devices are n-type, (ii) sources of the field-effect transistors of the first and second switching devices are coupled to each other, (iii) a drain of the field-effect transistor of the first switching device, an anode of the thyristor of the first switching device, and a cathode of the thyristor of the second switching device are coupled to the negative electrode of the first power supply source, (iv) the drain of the field-effect transistor of the second switching device, the anode of the thyristor of the second switching device, and the cathode of the thyristor of the first switching device are coupled to the positive electrode of the second power supply source, or (v) the negative electrode of the first power supply source is coupled to the negative electrode of the second power supply source by a third switching device, and the positive electrode of the first power supply source is coupled to the positive electrode of the second power supply source by a fourth switching device;
wherein (i) the field-effect transistors of the third and fourth switching devices are n-type, (ii) a source of the transistor of the third switching device and the cathode of the thyristor of the third switching device are coupled to the negative electrode of the second power supply source, (iii) the drain of the transistor of the third switching device and the anode of the thyristor of the third switching device are coupled to the negative electrode of the first power supply source; (iv) a source of the transistor of the fourth switching device and the cathode of the thyristor of the fourth switching device are coupled to the positive electrode of the second power supply source, and (v) the drain of the transistor of the fourth switching device and the anode of the thyristor of the fourth switching device are coupled to the positive electrode of the first power supply source.

16. The electric vehicle according to claim 15, wherein a first power supply source comprises a positive electrode coupled to a first conductive element of the electrical interconnection bus; and
wherein a second power supply source comprises a negative electrode coupled to a second conductive element of the electrical interconnection bus.

17. The electric vehicle according to claim 16, wherein a negative electrode of the first power supply source is coupled to a positive electrode of the second power supply source by first and second switching devices coupled in series and forming together a bidirectional conduction path between the negative electrode of the first power supply source and the positive electrode of the second power supply source.

18. The electric vehicle according to claim 17, wherein:
the field-effect transistors of the first and second switching devices are n-type;
the sources of the field-effect transistors of the first and second switching devices are coupled to each other;
the drain of the field-effect transistor of the first switching device, the anode of the thyristor of the first switching device, and the cathode of the thyristor of the second switching device are coupled to the negative electrode of the first power supply source; and
the drain of the field-effect transistor of the second switching device, the anode of the thyristor of the second switching device, and the cathode of the thyristor of the first switching device are coupled to the positive electrode of the second power supply source.

19. The electric vehicle according to claim 16, wherein the negative electrode of the first power supply source is coupled to the negative electrode of the second power supply source by a third switching device; and
wherein the positive electrode of the first power supply source is coupled to the positive electrode of the second power supply source by a fourth switching device.

20. The power electrical circuit according to claim 19, wherein:
the field-effect transistors of the third and fourth switching devices are n-type;
the source of the transistor of the third switching device and the cathode of the thyristor of the third switching device are coupled to the negative electrode of the second power supply source;
the drain of the transistor of the third switching device and the anode of the thyristor of the third switching device are coupled to the negative electrode of the first power supply source;
the source of the transistor of the fourth switching device and the cathode of the thyristor of the fourth switching device are coupled to the positive electrode of the second power supply source; and
the drain of the transistor of the fourth switching device and the anode of the thyristor of the fourth switching device are coupled to the positive electrode of the first power supply source.
